(19) United States
(12) Patent Application Publication
(10) Pub. No.: US 2010/0315264 A1
(43) Pub. Date: Dec. 16, 2010

(54) TRAFFIC LIGHT ASSEMBLY

(76) Inventor: JOHN H. TAROLLI, Laguna Niguel, CA (US)

Correspondence Address: ARDENT LAW GROUP, P.C., 2600 Michelson, Ste. 1700, Irvine, CA, 92612, US

(21) Appl. No.: 12/485,008

(22) Filed: Jun. 15, 2009

(51) Int. Cl. G08G 1/095

(52) U.S. Cl. 340/907

(57) ABSTRACT

The present invention generally comprises a traffic light assembly comprising a housing; at least one circular display screen disposed on a side of the casing; wherein the circular display screen has a central display region disposed in the center of the circular display, a circumferential display region disposed at a rim of the circular display surrounding the central display region; wherein the central display region displays at least one color selected from the group consisting of red, green, yellow, black, and white; wherein the circumferential display region displays at least one color selected from the group consisting of red, green, yellow, black, and white; and wherein the circumferential display region displays at least one color that is different from a color displayed by the central display region.

### CROSS-REFERENCE TO RELATED APPLICATIONS

Not Applicable.

### FIELD OF THE INVENTION

The field of the invention is related to traffic stop lights.

### BACKGROUND OF THE INVENTION

One can appreciate that traffic stop lights have been around for many years and besides from minor aesthetic differences, the basic utility of the traffic stop light containing three circles having the colors Red, Yellow and Green has become the standard in most countries, in particular the United States. Although the basic functioning of the current applications of the Traffic Stop Light are fine for the purposes its intended for, there exists a plethora of problems and issues with current Traffic Stop Light configurations that make it inefficient and ineffective. Thus the traffic light assembly subject matter of the present invention seeks to address those issues and provide solutions to such problems.

All referenced patents, applications and literatures are incorporated herein by reference in their entirety. Furthermore, where a definition or use of a term in a reference, which is incorporated by reference herein, is inconsistent or contrary to the definition of that term provided herein, the definition of that term provided herein applies and the definition of that term in the reference does not apply. The invention may seek to satisfy one or more of the above-mentioned desires. Although the present invention may obviate one or more of the above-mentioned desires, it should be understood that some aspects of the invention might not necessarily obviate them.

In these respects, the traffic light assembly subject matter according to the present invention substantially departs from the conventional concepts and designs of the prior art, and in so doing provides a traffic light assembly system that is not anticipated, rendered obvious, suggested, or even implied by any of the prior art traffic light assembly systems either alone or in combination thereof.

### SUMMARY OF THE INVENTION

In view of the foregoing disadvantages inherent in the known types of traffic light assemblies now present in the prior art, the general purpose of the present invention, which will be described subsequently in greater detail, is to provide a traffic light assembly that has the ability to provide more information to drivers in regards to signals and instruction.

Another object of the traffic light assembly subject matter of the present invention is to provide a traffic light assembly that in addition to showing color instruction, it provides visual instruction by way of containing visual enhancements such as additional shapes and lines;

Another object of the traffic light assembly subject matter of the present invention is to allow the ability to people with eye handicaps, such as color blindness or diminished eye function, to easily view and understand the instructions and information because of the added visual enhancements and less dependence on just color as the sole instruction/information indicator;

Another object of the traffic light assembly subject matter of the present invention is to provide a new standard for traffic light assemblies that can be easily understood and implemented worldwide, including the United States;

Another object of the traffic light assembly subject matter of the present invention is to provide the ability for the driver to see the information/instruction displayed on the traffic assembly light even in adverse weather conditions;

Another object of the traffic light assembly subject matter of the present invention is to reduce traffic related accidents due to failure of driver not being able to see the traffic stop lights and instruction/information or seeing the wrong instruction/information;

To attain this, the present invention generally comprises a traffic light assembly comprising a housing; at least one circular display screen disposed on a side of the casing; wherein the circular display screen has a central display region disposed in the center of the circular display, a circumferential display region disposed at a rim of the circular display surrounding the central display region; wherein the central display region displays at least one color selected from the group consisting of red, green, yellow, black, and white; wherein the circumferential display region displays at least one color selected from the group consisting of red, green, yellow, black, and white; and wherein the circumferential display region displays at least one color that is different from a color displayed by the central display region. In one present embodiment, the traffic light assembly subject matter of the present invention includes a housing; the assembly has at least three circular display screens, each of the at least three circular display screens has a central display region and a circumferential display region; wherein the at least three circular display screen include a first screen, a second screen, and a third screen; wherein the first screen has a circumferential display region that displays a continuous solid black band, and has a central display region that displays a non-black color; wherein the second screen has a circumferential display region that displays a band of black and non-black colors consecutively arranged in alternating order; wherein the first screen has a circumferential display region that displays a band of continuous solid non-black color, and a central display region that display a same color as the circumferential display region, and further having a solid black band disposed between the central display region and the circumferential display region; and wherein the non-black color is at least one selected from the group consisting of green, yellow, red, and white.

In addition, the traffic light assembly subject matter of the present invention can include a camera and additional sensors which can provide further ability to take pictures and/or video and be able to receive and signals to driver's vehicles that can automatically change the instruction and information on the traffic light assembly of the present invention upon certain needs, such as for emergency or police vehicles etc.

Various objects, features, aspects and advantages of the traffic assembly light subject matter of the present invention will become more apparent from the following detailed description of preferred embodiments of the invention, along with the accompanying drawings in which like numerals represent like components.

### BRIEF DESCRIPTION OF THE DRAWINGS

FIG. 1 is a perspective view of a traffic light assembly according to an aspect of the inventive subject matter.

FIG. 2 is a perspective view of an alternative embodiment of a traffic light assembly with according to an aspect of the inventive subject matter.

FIG. 3 is a front view of the circular display screen for a green light of a traffic light assembly with according to an aspect of the inventive subject matter.

FIG. 4 is a front view of the circular display screen for a green light with arrow displays of a traffic light assembly with according to an aspect of the inventive subject matter.

FIG. 5 is a front view of the circular display screen for a yellow light of a traffic light assembly with according to an aspect of the inventive subject matter.

FIG. 6 is a front view of the circular display screen for a yellow light with arrow displays of a traffic light assembly with according to an aspect of the inventive subject matter.

FIG. 7 is a front view of the circular display screen showing a blinking yellow light with an arrow display of a traffic light assembly with according to an aspect of the inventive subject matter.

FIG. 8 is a front view of the circular display screen for a red light of a traffic light assembly with according to an aspect of the inventive subject matter.

FIG. 9 is a front view of the circular display screen showing a blinking red light of a traffic light assembly with according to an aspect of the inventive subject matter.

FIG. 10 is a front view of the circular display screen showing a red light with arrow displays of a traffic light assembly with according to an aspect of the inventive subject matter.

FIG. 11 is a front view of the circular display screen for a red light with a white flash being emitted of a traffic light assembly with according to an aspect of the inventive subject matter.

FIG. 12 is a front view of the circular display screen for a blinking red light with a white flash being emitted of a traffic light assembly with according to an aspect of the inventive subject matter.

FIG. 13 is an illustration of an embodiment of a numerical display light providing a countdown with corresponding light displays.

FIG. 14 is an illustration of an embodiment of traffic light assembly depicting a light display progressions from stop (red), caution (yellow) and go (green).

### DETAILED DESCRIPTION OF THE INVENTION

The invention and is various embodiments can now be better understood by turning to the following detailed description of the preferred embodiments, which are presented as illustrated examples of the invention defined in the claims. It is expressly understood that the invention as defined by the claims may be broader than the illustrated embodiments described below.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following claims. For example, notwithstanding the fact that the elements of a claim are set forth below in certain combination, it must be expressly understood that the invention includes other combinations of fewer, more or different elements, which are disclosed herein even when not initially claimed in such combinations.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims therefore include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be exercised from the combination and that the claimed combination can in some cases be excised from the combination and that the claimed combination may be directed to a subcombination or variation of a subcombination.

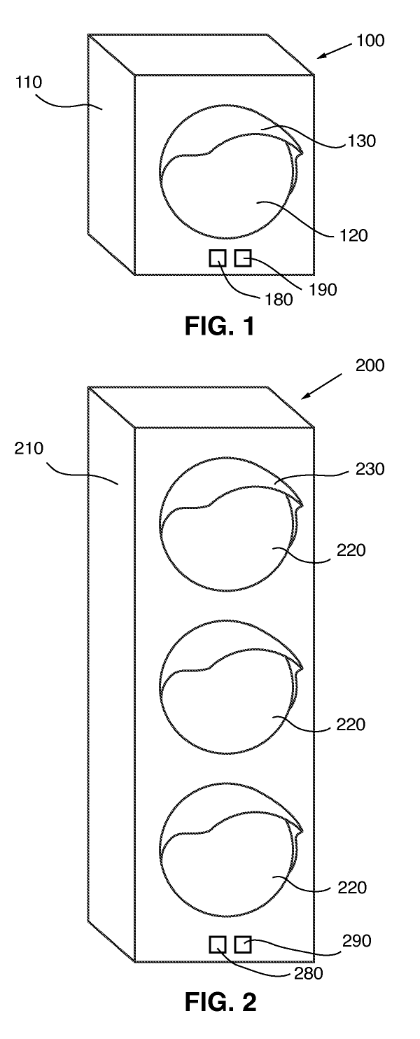

Referring now to FIG. 1, which illustrates the traffic light assembly for a single light 100 having a housing 110, a circular display screen 120, a lid 130, an optional camera 180, and a signal transmitter 190. In one preferred embodiment each single light is approximately 76 centimeters in diameter and the circular display screen is comprised of a platinum television screen although other various screens can be used such as LED, projection lamp, OLED, and LCD screens. A screen shield being comprised of transparent plastic and being 1 centimeter thick covering the entire light can also be used to protect the circular display screen 120 from damage. Each circular display screen 120 is surrounded by a square housing 110 being approximately 92 centimeters in diameter and 8 centimeters wide. In one preferred embodiment the housing 110 is comprised of tin and steel for stability and durability and is in the color black to make the color lights easier to distinguish and see. It is also contemplated that the traffic light contains one or more micro-processors which will allow it to perform certain processes and also send, receive and process transmitted signals.

In FIG. 2, a typical three light traffic light assembly 200 is shown being comprised of a housing 210, a circular display screen 220, a lid 230, an optional camera 280, and a signal transmitter 290. In another preferred embodiment, the three light traffic light assembly 200 can be configured in a horizontal fashion as opposed to a vertical fashion as shown in FIG. 2.

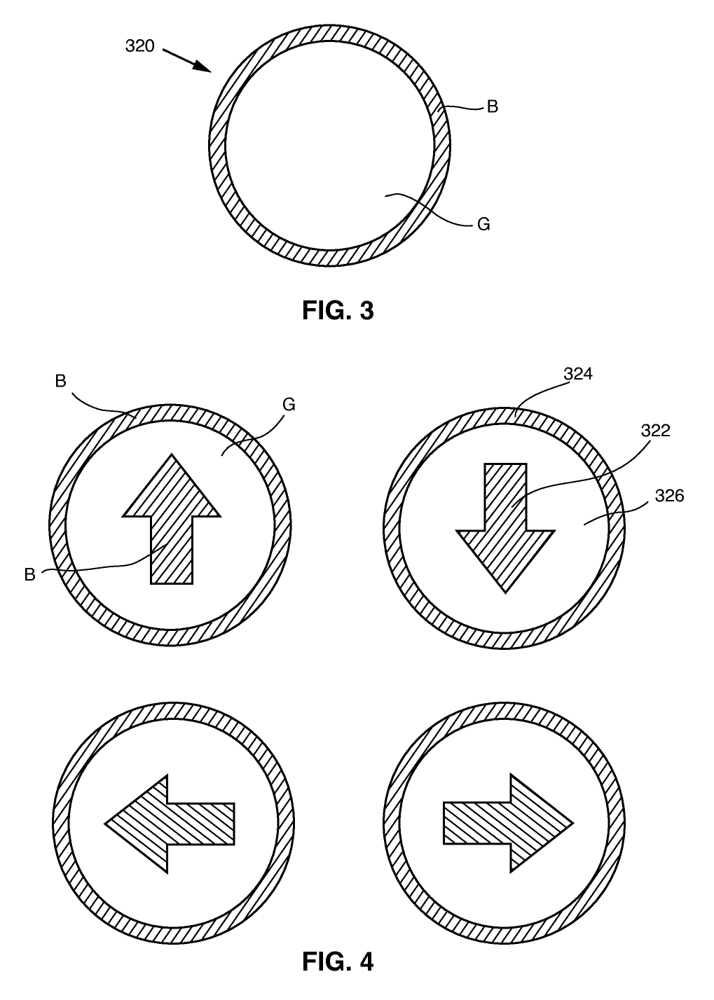

FIG. 3 shows one preferred embodiment of the circular display screen for the green light comprised of a green spherical center G and a black solid band B in the shape of an outer ring. Even if the driver is visually impaired (e.g. color blind) or the green color of the light is hard to distinguish because of external influences, the ability of the driver to see the spherical center G and the black solid band B, he or she can still recognize that the light is green by the visual markings of the light. FIG. 4 depicts the same green light with arrow displays 322 on the central display region 326 in the color of green G, which is surrounded by the circumferential display region 324 in the color black B. The arrow displays 322 are also in the color of black B and are approximately 60 centimeters in length from point to rear. The arrow display shaft is approximately 40 centimeters. From the point of the arrow to the arrow base is approximately 30 centimeters and the bases of the arrow are 10 centimeters each.

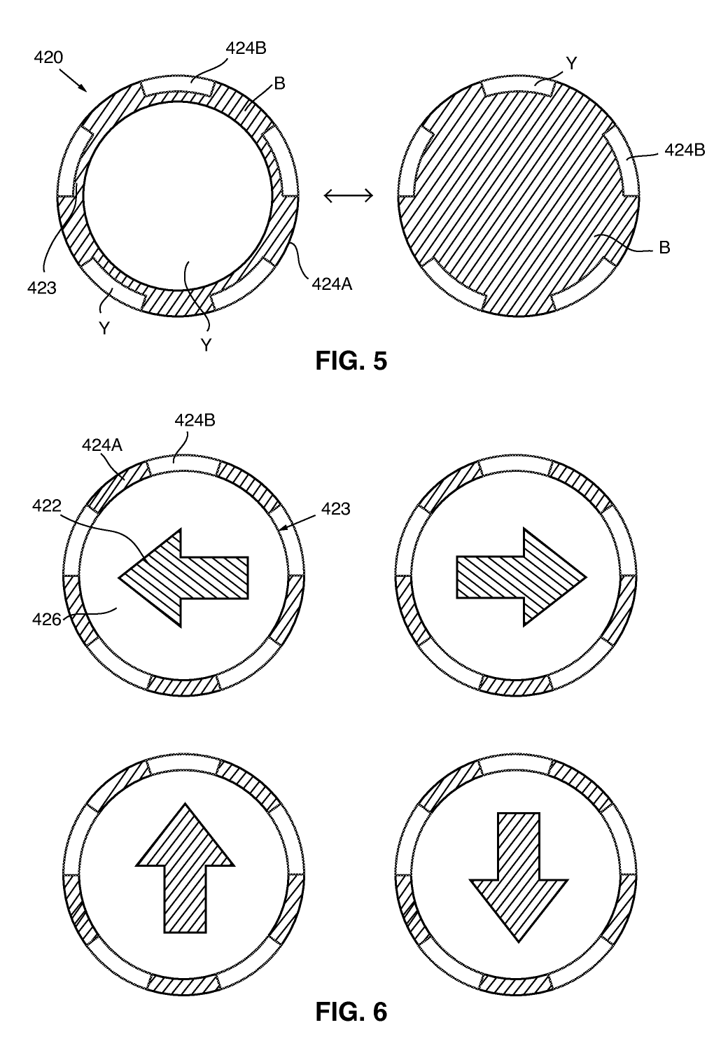

FIG. 5 shows one preferred embodiment of the circular display screen for the yellow light 420 comprised of a yellow spherical center Y and a black B solid band 423 in the shape of an outer ring and a circumferential display region 424 which is comprised of black color sections 424A and non-black color sections 424B. For the yellow light, the non-black color sections are in the color yellow Y. In one preferred embodiment, the yellow light 420 is capable of blinking. When blinking, the central display region 426 would change from solid yellow Y to solid black B but the non-black color sections 424B would remain. Even if the driver is visually impaired (e.g. color blind) or the yellow color of the light is hard to distinguish because of external influences, the ability of the driver to see the non-black color sections as dashed lines, he or she can still recognize that the light is yellow by the visual markings of the light. The non-color sections 424B are approximately 10 centimeters from the central display region 426.

FIG. 6 shows another preferred embodiment of the yellow light 420 with corresponding arrow displays 422 in the color of yellow Y. As seen in FIG. 6, the directions of the arrow displays 422 may be shown in variety of fashions including the typical up, down, right and left directional cues. The arrow displays 422 are also in the color of black B. Again, drivers can always recognize the light is yellow by seeing the dashed non-black color sections 424B, even if for instance that the driver is color blind.

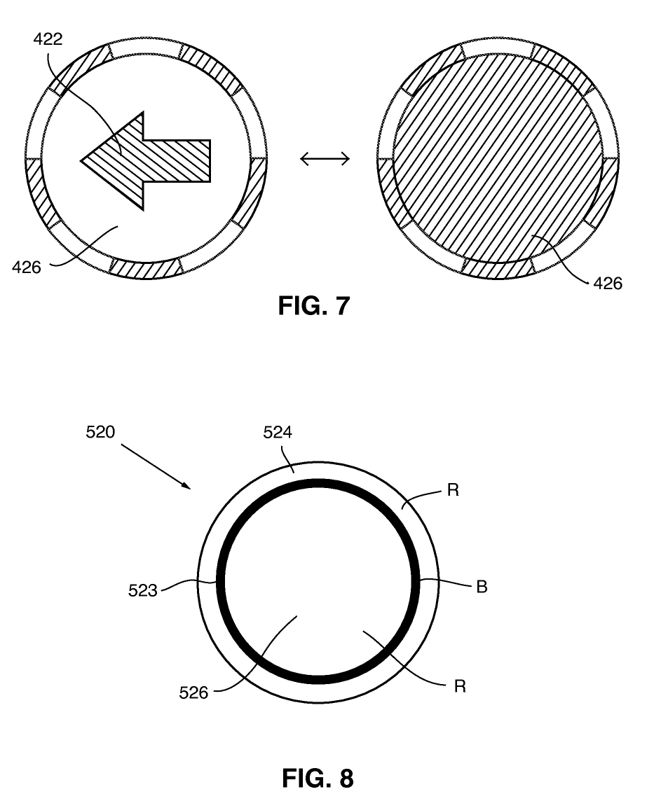

FIG. 7 provides another illustration of a preferred embodiment of a blinking yellow light 420 while containing an arrow display 422. Even while blinking, drivers will recognize that the light is yellow by the dashed non-black color sections that pertains to only the yellow light.

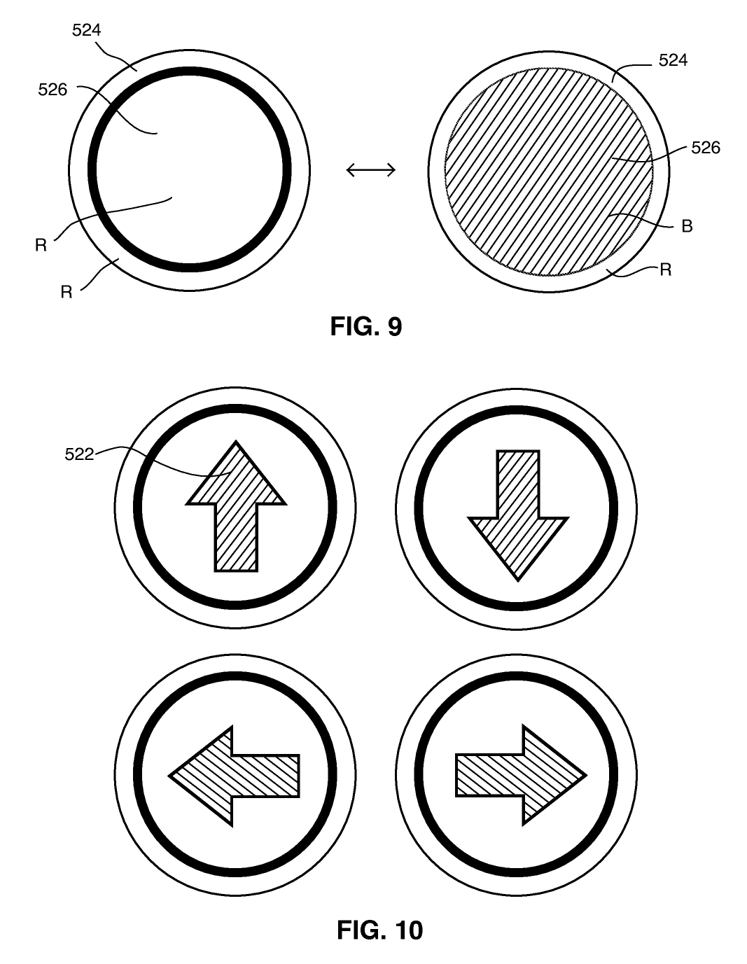

FIG. 8 shows one preferred embodiment of the circular display screen for the red light 520 comprised of a central display region 526 in the color of Red R and a solid black band 523 in the color black B, surrounded by a circumferential display region 524 in the color of red R. When blinking as shown in FIG. 9, the central display region 526 will switch from solid red R color to solid black B color, however the red R circumferential display region 523 will remain as a constant. FIG. 10 shows another preferred embodiment of the red light 520 with corresponding arrow displays 522 in the color of red R. The arrow displays 522 may be shown in variety of fashions including the typical up, down, right and left directional cues. The arrow displays 522 are also in the color of black B. Even if the driver is visually impaired (e.g. color blind) or the red color of the light is hard to distinguish because of external influences, the ability of the driver to see the solid black B band 523 and the circumferential display region 524 as a solid unbroken ring, he or she can still recognize that the light is red by the visual markings of the light.

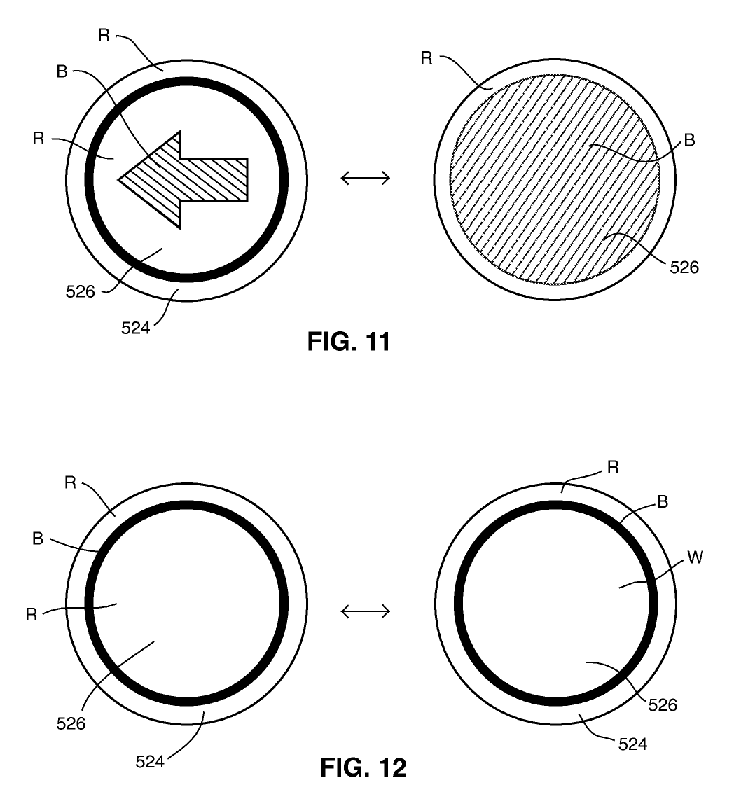

FIG. 11 provides another illustration of a preferred embodiment of a blinking red light 520 while containing an arrow display 522. In one preferred embodiment, for certain emergency circumstances, the red light 520 has the ability to depict a white flash W to attract more attention from drivers as shown in FIG. 12. The drivers will still understand that the light is Red through the circumferential display region 524 as a solid unbroken ring.

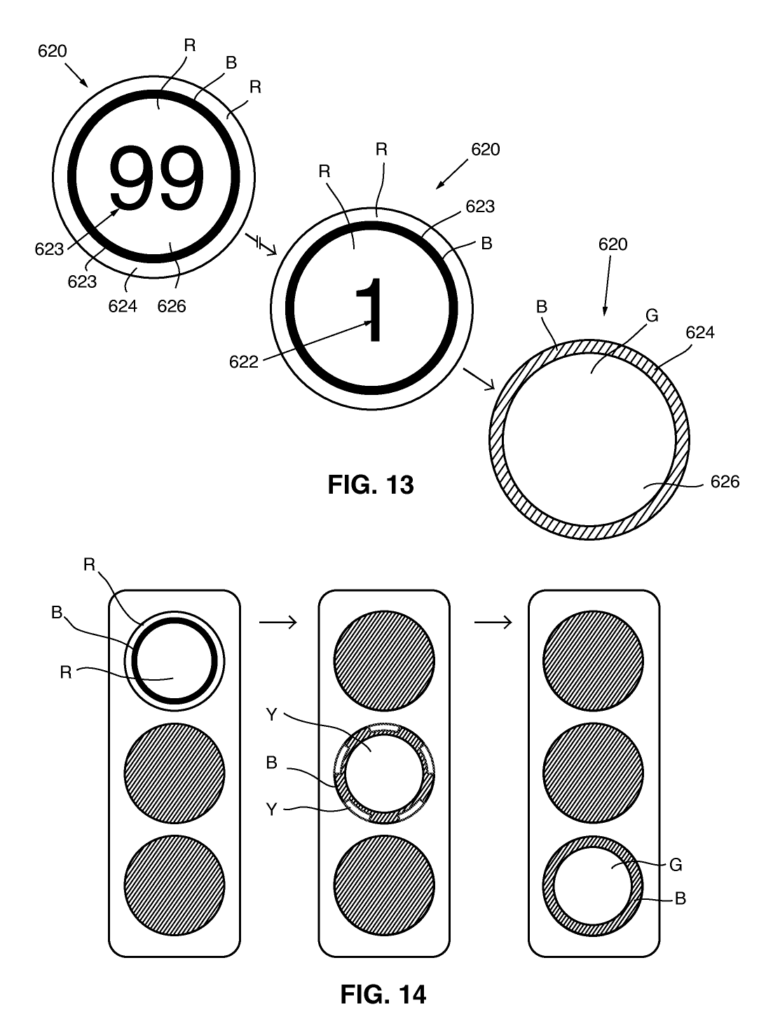

FIG. 13 shows one preferred embodiment of circular display screen for a countdown traffic light that changes color 620 comprising of a numerical display 620, a solid black B band 623, a circumferential display region 624, and a central display region 626. This countdown traffic light provides added features to the traffic light assembly by being able to provide additional information to drivers. Aside from having a numerical display 620, one can contemplate that the numerical display 620 may feature other information such as traffic congestion, accident warnings/notifications, amber alerts and a host of other highway and traffic related information. In order for the light to be able to perform and display a countdown or other informative displays, it is contemplated that the traffic assembly light contains a microprocessor to perform such processes.

Turning to FIG. 14, one preferred embodiment of a full traffic light assembly is shown comprising of the red, yellow and green lights as described above. A typical scenario of a red-light stop transitioning to a green-light go is clearly depicted.

Thus, specific embodiments and applications of the traffic light assembly subject matter contained in the present invention have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Insubstantial changes from the claimed subject matter as viewed by a person with ordinary skill in the art, now known or later devised, are expressly contemplated as being equivalent within the scope of the claims. Therefore, obvious substitutions now or later known to one with ordinary skill in the art are defined to be within the scope of the defined elements. The claims are thus to be understood to include what is specifically illustrated and described above, what is conceptually equivalent, what can be obviously substituted and also what essentially incorporates the essential idea of the invention. In addition, where the specification and claims refer to at least one of something selected from the group consisting of A, B, C . . . and N, the text should be interpreted as requiring only one element from the group, not A plus N, or B plus N, etc.

What is claimed is:

1. A traffic light assembly comprising:
a housing;
at least one circular display screen disposed on a side of the casing;
wherein the circular display screen has a central display region disposed in the center of the circular display, a circumferential display region disposed at a rim of the circular display surrounding the central display region;
wherein the central display region displays at least one color selected from the group consisting of red, green, yellow, black, and white;
wherein the circumferential display region displays at least one color selected from the group consisting of red, green, yellow, black, and white; and
wherein the circumferential display region displays at least one color that is different from a color displayed by the central display region.

2. The traffic light assembly as recited in claim 1, wherein the circumferential display region displays alternating bands of a plurality of black color sections and a plurality of non-black color sections.

3. The traffic light assembly as recited in claim 2, wherein the non-black color is yellow, and wherein the central display region displays the yellow color.

4. The traffic light assembly as recited in claim 2, wherein the central display region further displays an arrow or a numeric number in a color that is different from a color of the central display region.

5. The traffic light assembly as recited in claim 4, wherein the central display region blinks, and the traffic light assembly further comprises a microprocessor coupled to the at least one circular display screen to control the blinking.

6. The traffic light assembly as recited in claim 1, wherein the circumferential display region displays a solid continuous red color band, and the central display region displays the red color, and a solid black band is disposed between the circumferential display region and the central display region.

7. The traffic light assembly as recited in claim 6, wherein the central display region further displays an arrow or a numeric number in a color that is different from red.

8. The traffic light assembly as recited in claim 6, wherein the central display region blinks by alternating a display of red color and a display of white color.

9. The traffic light assembly as recited in claim 7, further comprising:
a microprocessor coupled to the circular display screen and performs a countdown, the countdown is expressed by displaying the numeric numbers in decreasing order;
wherein at the end of the countdown the central display region displays the green color as opposed to the red color; and
wherein at the end of the countdown the circumferential display region displays a black color as opposed to the red color.

10. A traffic light assembly comprising:
a housing;
the assembly has at least three circular display screens, each of the at least three circular display screens has a central display region and a circumferential display region;
wherein the at least three circular display screen include a first screen, a second screen, and a third screen;
wherein the first screen has a circumferential display region that displays a continuous solid black band, and has a central display region that displays a non-black color;
wherein the second screen has a circumferential display region that displays a band of black and non-black colors consecutively arranged in alternating order;
wherein the first screen has a circumferential display region that displays a band of continuous solid non-black color, and a central display region that display a same color as the circumferential display region, and further having a solid black band disposed between the central display region and the circumferential display region; and
wherein the non-black color is at least one selected from the group consisting of green, yellow, red, and white.

11. The traffic light assembly as recited in claim 10 further comprising:
a receiver to receive a signal transmitted from an emergency vehicle;
a microprocessor to process the signal, and, upon receiving the signal, to change the traffic light to display a red light status.

12. The traffic light assembly as recited in claim 10 further comprising:
a signal transmitter to transmit information regarding a light color status of the traffic light, the light color status includes the red light status, a green light status, and a yellow light status;
a vehicle unit to receive said information and alert a driver of the vehicle of the light color status.

13. The traffic light assembly as recited in claim 10 further comprising a camera coupled to the housing.

14. The traffic light assembly as recited in claim 10, wherein the screen is one selected from a group consisting of a plasma screen, a LCD screen, a TFT screen, a TFD screen, an OLED screen, a LED screen, and a STN screen.

15. A method of light signal system, the system comprising:
using a light signal apparatus having at least one circular display screen, wherein each of the at least one display screen has a central display region surrounded by a circumferential display region, wherein the central display region is capable of displaying a color different from a color of the circumferential display region; and
providing a plurality of distinctive pattern combinations, each combination designating a light signal status selected from the group consisting of a red signal status, a yellow signal status, and a green signal status.

16. The method as recited in claim 15, wherein one of the pattern combinations is comprised of displaying a first color in the central display region, and concurrently displaying a continuous solid band of second color in the circumferential display region, wherein the first color has a different color from the second color.

17. The method as recited in claim 15, wherein one of the pattern combinations is comprised of displaying a first color in the central display region, and concurrently displaying a band of punctuated black color sections in the circumferential display region.

18. The method as recited in claim 15, wherein one of the pattern combinations is comprised of displaying a first color in the central display region, and concurrently displaying a band of continuous solid first color in the circumferential display region, and wherein a solid continuous black color band is disposed between the central display region and the circumferential display region.

19. The method as recited in claim 17, further comprising the step of making the central display region blink.

20. The method as recited in claim 17, further comprising the step of displaying an arrow or a numeric number in the central display region.
